(19) United States
(12) Patent Application Publication
(10) Pub. No.: US 2018/0003431 A1
(43) Pub. Date: Jan. 4, 2018

(54) STORAGE SYSTEM FOR FUELS

(71) Applicant: Electro-Motive Diesel, Inc., LaGrange, IL (US)

(72) Inventors: Aaron Gamache Foege, Westmont, IL (US); Veronica Anne Hannink, Westmont, IL (US)

(73) Assignee: Electro-Motive Diesel, Inc., LaGrange, IL (US)

(21) Appl. No.: 15/200,867

(22) Filed: Jul. 1, 2016

(51) Int. Cl. F25J 1/00; F17C 13/08; F17C 3/02; F17C 9/00

(52) U.S. Cl. CPC F25J 1/0025; F17C 9/00; F17C 13/083; F17C 3/022; F17C 2260/031; F17C 2270/0581; F17C 2221/035

(57) ABSTRACT

A condensation system for a reservoir, which stores fuel cryogenically, is disclosed. A portion of the fuel exists as a boil-off gas with a first vapor quality. The condensation system includes an absorption unit coupled to the reservoir and is configured to receive and mix the boil-off gas with a refrigerant, forming a liquid solution. A distillation unit is coupled to the absorption unit to receive the liquid solution at a supplemented pressure, and is configured to separate the fuel to a gaseous state from the liquid solution. Further, a cooling circuit is configured to receive the fuel in the gaseous state from the distillation unit at the supplemented pressure and a supplemented temperature, and deliver the fuel to the reservoir at a lower pressure and a temperature, with a vapor quality lower than the first vapor quality.

### TECHNICAL FIELD

The present disclosure relates to a condensation system for fuels which may exist as a boil-off gas within reservoirs. More particularly, the present disclosure relates to a condensation system that is based on a vapor absorption refrigeration cycle.

### BACKGROUND

Natural gas has been well received as a plentiful, low emission, and viable alternative to traditional fuels such as diesel. Natural gas, however, has a lower energy density than traditional fuels such as diesel and gasoline. As a result, mobile machines, such as locomotive systems, generally use liquefied natural gas (“LNG”) as fuel to power a locomotive movement. To maintain natural gas in liquid form at atmospheric pressure, LNG's temperature must remain about −160° Celsius. Mobile machines, such as locomotives, utilizing LNG as a fuel, therefore, typically store LNG in insulated tanks. However, some heat can still enter the tank because of an imperfect or worn out tank insulation, causing some of the LNG to change to vapor.

Such vapor (also conventionally termed as “boil-off”) accumulates in the upper portions of the tank. Over a period, as more and more vapor is generated, a pressure within the tank may increase. The increasing pressure, if left unchecked, may damage the tank and can even cause the tank to explode. Traditional LNG systems, therefore, vent the vapor (composed mostly of methane) to the atmosphere. However, according to stricter emission regulations, it is prohibited to vent vapor to the atmosphere as such vapor contributes to greenhouse gas emissions. Some LNG systems ignite the gaseous fuel as the gaseous fuel is vented to the atmosphere, thus reducing the amount of methane release. However, such an ignition process is beset with the release of substantially untreated emissions to the atmosphere. Moreover, such a process results in a wastage of potential fuel energy.

U.S. Pat. No. 5,956,971 ('971 reference) relates to a process for producing pressurized liquid rich in methane from a multi-component feed stream containing methane and a freezable component having a relative volatility less than that of methane. The multi-component feed stream is introduced into a separation system having a freezing section and a distillation section. The separation system produces a vapor stream rich in methane and a liquid stream rich in the freezable component. At least a portion of the vapor stream is cooled to produce a liquefied stream rich in methane. A first portion of the liquefied stream is returned to the separation system to provide refrigeration to the separation system, while a second portion of the liquefied stream is withdrawn as a pressurized liquefied product stream rich in methane. The '971 reference discloses a storage means which receives this liquid stream. However, the '971 reference is silent on recovering any gaseous vapor formed within the storage means subsequent or prior to the receipt of the liquid stream.

### SUMMARY OF THE INVENTION

In one aspect, the disclosure is directed towards a condensation system for a reservoir that is configured to store a fuel cryogenically. A portion of the fuel exists as a boil-off gas within the reservoir with a first vapor quality. The condensation system includes an absorption unit, a distillation unit, and a cooling circuit. The absorption unit is fluidly coupled to the reservoir. The absorption unit is configured to receive a refrigerant and the boil-off gas and facilitate a mixing between the boil-off gas and the refrigerant to form a liquid solution. The distillation unit is fluidly coupled to the absorption unit and is adapted to receive the liquid solution at a supplemented pressure. the distillation unit is configured to separate the fuel to a gaseous state from the liquid solution. The cooling circuit is fluidly coupled between the distillation unit and the reservoir. The cooling circuit is configured to receive the fuel in the gaseous state from the distillation unit at the supplemented pressure and a supplemented temperature. Moreover, the cooling circuit is configured to deliver the fuel to the reservoir at a pressure and a temperature respectively lower than the supplemented pressure and the supplemented temperature, and with a vapor quality lower than the first vapor quality.

In another aspect, the disclosure relates to a storage system for a fuel. The storage system includes a reservoir, an absorption unit, a distillation unit, and a cooling circuit. The reservoir is configured to store the fuel cryogenically, with a portion of the fuel existing as a boil-off gas with a first vapor quality. The absorption unit is fluidly coupled to the reservoir. The absorption unit is configured to receive a refrigerant and the boil-off gas and facilitate mixing between the boil-off gas and the refrigerant to form a liquid solution. The distillation unit is fluidly coupled to the absorption unit to receive the liquid solution at a supplemented pressure. The distillation unit is further configured to separate the fuel to a gaseous state from the liquid solution. The cooling circuit is fluidly coupled between the distillation unit and the reservoir. The cooling circuit is configured to receive the fuel in the gaseous state from the distillation unit at the supplemented pressure and a supplemented temperature, and deliver the fuel to the reservoir at a pressure and a temperature respectively lower than the supplemented pressure and the supplemented temperature, and with a vapor quality lower than the first vapor quality.

In yet another aspect, the disclosure is directed to a method for condensing a fuel. The fuel is cryogenically stored in a reservoir. Upon a presence of a portion of the fuel as a boil-off gas with a first vapor quality, the method includes extracting the boil-off gas to an absorption unit and mixing the boil-off gas with a refrigerant in the absorption unit to form a liquid solution. Thereafter, the method includes pressurizing the liquid solution to a supplemented pressure by a pump and separating the fuel into a gaseous state from the liquid solution, at a supplemented temperature, in a distillation unit. Next, the method includes lowering the supplemented temperature and the supplemented pressure of the fuel in the gaseous state by a cooling circuit and delivering the fuel to the reservoir at a lower pressure and a lower temperature, with a vapor quality lower than the first vapor quality.

### BRIEF DESCRIPTION OF THE DRAWINGS

FIG. 1 is an exemplary machine including a storage system to store a fuel, in accordance with the concepts of the present disclosure;

FIG. 2 is a schematic representation of the storage system having a reservoir depicted in conjunction with a condensation system for recovering the fuel, in accordance with the concepts of the present disclosure; and

FIG. 3 is a flowchart depicting a method of operation of the condensation system of FIG. 2, in accordance with the concepts of the present disclosure.

### DETAILED DESCRIPTION

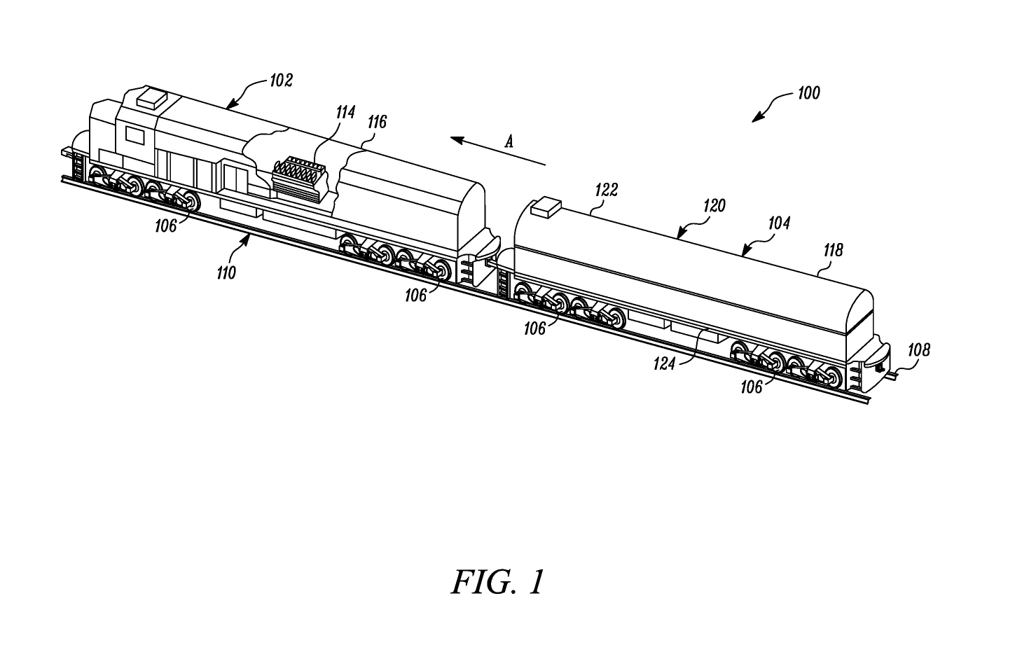

Referring to FIG. 1, a machine 100 is disclosed. The machine 100 is a locomotive system. The machine 100 includes an engine assembly 102 and a rolling stock 104. In an embodiment, the machine 100 includes a single engine assembly, although it is possible to have multiple engine assemblies connected to each other to facilitate machine movement. As an example, the machine 100 may include a train propelled by a single engine assembly or by multiple engine assemblies. Further, other known arrangements of locomotives may also be contemplated. A number of wheels 106 are positioned throughout a length of the machine 100 in a known manner. The wheels 106 engage tracks 108 of an associated railroad 110, supporting and facilitating traversal of the machine 100 over an expanse of the railroad 110. Although aspects of the present disclosure are applicable to a locomotive system, aspects of the present disclosure are applicable to various other machines and environments.

The engine assembly 102 represents one of the commonly applied power generation units in locomotive systems. The engine assembly includes an engine 114, such as an internal combustion engine. The engine 114 is housed within an engine compartment 116 of the engine assembly 102. The engine 114 embodies a self-propelled engine that is powered at least party or fully by fuel, such as liquefied natural gas (LNG). More particularly, the engine 114 may be a high-pressure natural gas engine that is configured to receive a quantity of gas by direct injection. In general, the engine 114 may use natural gas (NG), propane gas, methane gas, or any other suitable gaseous fuel, singularly or in combination with each other, to power the engine's operation. Alternatively, the engine 114 may be based on a dual-fueled engine system, a diesel-fueled engine system, or a dual-fueled electric engine system. The engine 114 may embody a V-type, an in-line, or a varied configuration as is conventionally known. The engine 114 is a multi-cylinder engine, although aspects of the present disclosure are applicable to engines with a single cylinder as well. Further, the engine 114 may be one of a two-stroke engine, a four-stroke engine, or a six-stroke engine. Although not limited, the engine 114 may represent power generation units, such as a compression ignition engines powered by diesel fuel, a stratified charge compression ignition (SCCI) engine, or a homogeneous charge compression ignition (HCCI) engine, or spark ignition engines powered by a cryogenic fuel. Although the configurations disclosed, aspects of the present disclosure need not be limited to a particular engine type.

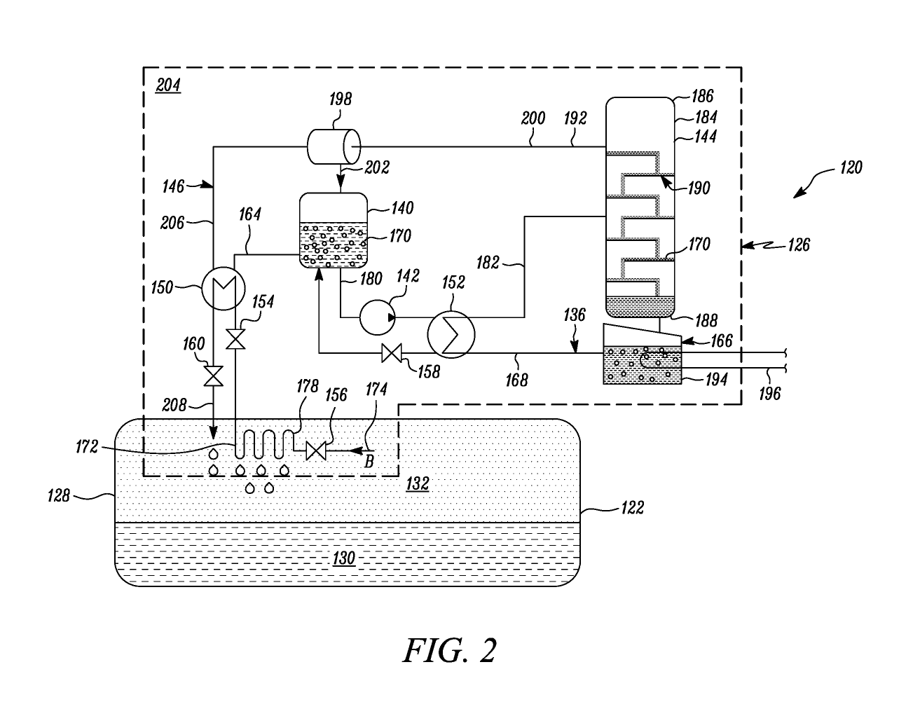

The rolling stock 104 is configured to trail behind the engine assembly 102 along the expanse of the railroad 110. The rolling stock 104 includes a number of compartments, perhaps used for transporting good, passengers, etc. The rolling stock 104 also includes a tender 118 that is arranged sequentially behind the engine assembly 102, as observed along a forward movement of the machine 100 (direction, A). The tender 118 includes a storage system 120 that facilitates storage of fuels, such as LNG, for use within the engine 114. However, various other fuels may also be considered. More specifically, the storage system 120 includes a reservoir 122 (see FIG. 2) in which the fuel is stored. The reservoir 122 may be a cryogenic fuel reservoir having an insulated, single or multi-walled configuration. The reservoir 122 is configured to store the fuel cryogenically at relatively low temperatures. In one exemplary embodiment, the reservoir 122 is configured to store the fuel at a temperature below −160° C. Further, the reservoir 122 may be mounted to a base platform 124 of the tender 118. In turn, the base platform 124 may be supported on the tracks 108 of the railroad 110 by wheels 106. Also, the reservoir 122 is fluidly connected to the engine 114 by known means to supply the fuel to the engine 114 during operation.

Referring to FIG. 2, aspects of the storage system 120 is schematically shown and discussed in further detail. The storage system 120 includes the reservoir 122, as already noted above, and a condensation system 126 that works in conjunction with the reservoir 122. As heat may seep past walls 128 of the reservoir 122, at least a portion of the fuel housed cryogenically within the reservoir 122 may become vapor (as boil-off gas 132) over a period. At any given point in time, therefore, the fuel may exist in dual forms within the reservoir 122—in a liquid state 130 and as boil-off gas 132. In an embodiment, the fuel in the liquid state 130 corresponds to LNG, while the boil-off gas 132 corresponds to Natural Gas (NG). A vapor quality of the boil-off gas 132 (i.e. a mass fraction of vapor in the associated mixture), within the reservoir 122 is represented as a first vapor quality (denoted as [symbol] ).

As an example, the first vapor quality of boil-off gas 132 within the reservoir 122 is equal to 1 (i.e. [symbol] =1). In addition to said example, the boil-off gas 132 may be maintained within the reservoir 122 at a pressure of 8 bar, and at a temperature of 145 Kelvin.

The condensation system 126 is configured to extract and recover portions of the boil-off gas 132, convert the boil-off gas 132 to the liquid state, and deliver the fuel back to the reservoir 122, in the liquid state 130. The condensation system 126 works on the principle of a vapor absorption refrigeration cycle to recover the fuel. To this end, the condensation system 126 includes a fuel recovery circuit 136 that may be construed as a fuel re-liquefying or a fuel liquefaction assembly that is inclusive of multiple fluid lines to fluidly couple one or more components of the condensation system 126, to each other. Components of the condensation system 126 include an absorption unit 140, a pump 142, a distillation unit 144, a cooling circuit 146, a set of heat exchangers 150, 152, and a number of valves. The number of valves include a shutoff valve 154 and a set of expansion valves 156, 158, 160. The heat exchangers 150, 152 and the expansion valves 156, 158, 160 are positioned at appropriate locations of the fuel recovery circuit 136, as will become apparent as the discussion proceeds.

The absorption unit 140 is generally maintained at a pressure closer to atmospheric pressure. The absorption unit 140 includes a chamber that is fluidly coupled to the reservoir 122 by a first fluid line 164. In that manner, the absorption unit 140 is configured to receive the boil-off gas 132) from the reservoir 122 via the first fluid line 164. In addition, the absorption unit 140 is configured to receive a refrigerant, such as propane, from a generator assembly 166 (discussed later) of the distillation unit 144. A receipt of propane by the absorption unit 140 is facilitated using a second fluid line 168 that is fluidly coupled between the absorption unit 140 and the generator assembly 166. According to the present disclosure, the boil-off gas 132 may be comprised substantially of methane, while the refrigerant may be propane.

The absorption unit 140 is configured to facilitate a thorough mixing of the boil-off gas 132 with the refrigerant, and therefore, combine and effectuate an absorption of the boil-off gas 132 into the refrigerant. In that way, the absorption unit 140 facilitates the formation of a homogenous liquid solution (or simply a liquid solution 170) comprised of 10% methane and 90% propane. Variations to this percentage of methane and propane in the liquid solution 170 is possible. The thoroughly mixed liquid solution 170 is passed on further into the fuel recovery circuit 136 of the condensation system 126 for further processing.

In an embodiment, the absorption unit 140 includes a mixing system (not shown), such as inclusive of blades and a rotor that may rotate or manipulate in a known fashion to enhance mixing of the two compounds (methane and propane) with each other. In an embodiment, a pressure of the boil-off gas 132 (methane) received within the absorption unit 140 is 2 bar and a temperature of the boil-off gas 132 (methane) is 200 Kelvin. Similarly, a temperature and pressure of the refrigerant (propane) received within the absorption unit 140 is respectively at less than/equal to 200 Kelvin and 2 bar.

The first fluid line 164 facilitates a transmission of the boil-off gas 132 from the reservoir 122 to the absorption unit 140. The first fluid line 164 includes known measures to position the shutoff valve 154 to facilitate a regulation of the boil-off gas 132 to the absorption unit 140. In an embodiment, the shutoff valve 154 is a one way check valve that facilitates a unidirectional flow of boil-off gas 132 from the reservoir 122 to the absorption unit 140 (direction, B). In an embodiment, the shutoff valve 154 is configured to be activated (or opened) as a pressure within the reservoir 122 exceeds beyond a pressure threshold value. As an example, the pressure threshold value is about 6 bar to 8 bar, or around 100 pound per square inch (psi), although other pressure threshold values may be contemplated. Accordingly, the shutoff valve 154, arranged on the first fluid line 164, may be configured according to different pressure requirements of the engine 114 and/or the reservoir 122. In an embodiment, the shutoff valve 154 is configured to be activated by a machine operator.

Further, the first fluid line 164 includes an extension line 172 that extends into the reservoir 122 to define a vapor receiving end 174 within the reservoir 122. The extension line 172 includes the expansion valve 156, that is also referred to as a supplementary expansion valve 156, arranged at the vapor receiving end 174. The supplementary expansion valve 156 is configured to receive the boil-off gas 132 from the reservoir 122, at a pressure prevalent within the reservoir 122 (such as 8 bar), and expand and deliver the boil-off gas 132 at a reduced pressure (such as 2 bar) to the absorption unit 140. Given that the boil-off gas 132 (comprised mostly of methane) is characterized to cool relatively rapidly as an associated pressure is lowered (by the supplementary expansion valve 156), a section of the extension line 172, downstream to the supplementary expansion valve 156, includes or acts as a heat exchanging section 178. This downstream arrangement of the heat exchanging section 178 relative to the supplementary expansion valve 156 may be envisioned along a flow direction of the boil-off gas 132 (direction, B). Both the supplementary expansion valve 156 and the heat exchanging section 178 are positioned within the reservoir 122. The heat exchanging section 178 acts as a primary heat exchanger (or a first stage fuel re-liquefier) to convert a surrounding boil-off gas 132 within the reservoir 122 to a liquefied fuel. A cooling provided by the heat exchanging section 178 facilitates a first stage cooling to be imparted to the boil-off gas 132 housed within the reservoir 122. Such a cooling causes a considerable portion of the boil-off gas 132 to condense and fall into the reservoir 122 under gravity.

The pump 142 is fluidly coupled to the absorption unit 140 and is configured to receive and or retrieve the liquid solution 170, formed in the absorption unit 140, using a third fluid line 180. In particular, the pump 142 is configured to pressurize the liquid solution 170 to a certain level, and deliver the resulting pressurized liquid solution to the distillation unit 144 by a fourth fluid line 182. In general, the pump 142 may function as a primary power source for the condensation system 126, facilitating a pressurized flow of different states of the fuel, or of the fuel in combination with the refrigerant, across the fuel recovery circuit 136 in a manner as will be appended below. The pump 142 may be a fixed displacement pump, although in some embodiments a variable displacement pump may be contemplated.

In an exemplary embodiment, the pump 142 is configured to pressurize the liquid solution 170 to a supplemented pressure of 60 bar from the pressure of 2 bar maintained within the absorption unit 140. In an embodiment, the pump 142 is a cryogenic pump that is also primarily applied to supply fuel to the combustion chambers within the engine 114. In an embodiment, the pump 142 may be an existing pump unit within the machine 100 that is perhaps configured to perform a variety of tasks. As an example, the pump 142 may selectively be used to pump fuel to the engine 114 for combustion and subsequent power generation.

The distillation unit 144 is fluidly coupled to the absorption unit 140, with the pump 142 fluidly coupled in between the distillation unit 144 and the absorption unit 140. The distillation unit 144 is configured to receive the liquid solution 170 at the supplemented pressure (as pressurized by the pump 142), and thereafter, separate methane (fuel) from the liquid solution 170 as a vapor (or as fuel in the gaseous state) and propane as a liquid. To this end, the distillation unit 144 includes a fractional distillation column 184 that includes a first end portion 186 and a second end portion 188. The first end portion 186 is positioned at an elevation relative to the second end portion 188, and, in general, the second end portion 188 forms a base of the distillation unit 144. The distillation unit 144 includes a set of packing trays 190 that are arranged as sequential stack plates along a length of the fractional distillation column 184. The set of packing trays 190 are arranged in a zig zag manner and define a sinuous flow path for the liquefying propane in the fractional distillation column 184 to flow out into the generator assembly 166 by gravity feed. At each successive packing tray 190, as viewed from the second end portion 188 to the first end portion 186, the liquid solution 170 acquires a weaker propane and a stronger methane solution, until eventually methane vapor is released from the first end portion 186 into a fifth fluid line 192 of the fuel recovery circuit 136.

The generator assembly 166 of the distillation unit 144 is positioned adjacent (or below) the second end portion 188, along an elevation of the fractional distillation column 184. The generator assembly 166 includes a chamber 194 and a heating element 196 that works in conjunction with the chamber 194. Given that a boiling point of methane (fuel) is lower than a boiling point of the propane (refrigerant), as heat is applied by the heating element 196, methane is separated from the liquid solution 170 (or propane) as vapor. More particularly, the distillation unit 144 is configured to facilitate an exit of the separated methane vapor out into the fifth fluid line 192 though the first end portion 186. As separation is brought about by an increased temperature, as imparted by the heating element 196, methane is separated from propane at a supplemented temperature, or at a relatively higher temperature in relation to a temperature possessed by the liquid solution 170 before an entrance into the distillation unit 144. Simultaneous to the release of methane, the distillation unit 144 is configured to separate propane as a liquid, drain the liquefied propane by gravity feed through the packing trays 190, and collect the liquefied propane within the chamber 194 through the second end portion 188. The volume of propane collected within the chamber 194 may possess the supplemented pressure (for example 60 bar) as well.

The heating element 196 is assembled such that a portion of the heating element 196 is located within the chamber 194 of the generator assembly 166, as shown. It is however possible for the heating element 196 to be operably positioned elsewhere. For example, the heating element 196 may be in abutment to walls of the chamber 194 so as to impart heat into the chamber 194 by conduction. The heating element 196 may be instituted as an extension of a pre-existing heat transfer flow path of the machine 100, such as of the engine 114, that is altered or modified to also extend into the chamber 194. For example, heat dissipated from the engine 114 may form a source of heat energy for the heating element 196, and by which the heating element 196 may raise a temperature of the chamber 194, thereby facilitating propane liquefaction. According to an example, the heating element 196 is a fluid pipe that carries a coolant, such as glycol, that periodically entrains heat from the engine 114, dissipates at least a portion of the heat into the chamber 194, and is then withdrawn for processing as usual.

The generator assembly 166 (or chamber 194) is fluidly coupled to the absorption unit 140 via the second fluid line 168. The second fluid line 168 facilitates replenishment of the absorption unit 140 with propane as and when a subsequent quantity of boil-off gas 132 is received within the absorption unit 140 from the reservoir 122. The second fluid line 168 includes the expansion valve 158. The expansion valve 158 is configured to facilitate a reduction of the supplemented pressure of propane held within the chamber 194 before propane is re-introduced into the absorption unit 140. In an exemplary embodiment, the expansion valve 158 facilitates a reduction in pressure of propane to 2 bar from the supplemented pressure of 60 bar.

In principle, the distillation unit 144 is configured to reverse a functional output of the absorption unit 140, i.e., the distillation unit 144 splits the liquid solution 170 formed by the absorption unit 140 by way of varying a temperature of the liquid solution 170 in the fractional distillation column 184. Temperature variation is brought about by the heating element 196. However, if there remains a percentage of methane within the propane in the liquid state (perhaps due to a lower heating capability of the heating element 196), the resulting liquid solution 170 in the chamber 194 is redirected to the absorption unit 140 via the second fluid line 168. In that manner, it is ensured that a cyclical process of fuel regeneration is repeated until methane is appropriately separated from propane. Conversely, if the heating element 196 exhibits a higher heating capacity at any given point, portions of propane may also escape as vapor from the first end portion 186, along with vaporized methane, into the fifth fluid line 192. To counter a release of propane from the first end portion 186, the fifth fluid line 192 includes provisions that enable the released propane to be separated from methane, as will be understood by the forthcoming description.

The fifth fluid line 192 forms the cooling circuit 146 of the condensation system 126. The fifth fluid line 192 is fluidly coupled between the distillation unit 144 and the reservoir 122. The fifth fluid line 192 is configured to receive methane as fuel in the gaseous state from the first end portion 186 of the fractional distillation column 184 and return a condensed form of methane (i.e. liquefied fuel) to the reservoir 122. More particularly, the fuel in the gaseous state is received into the fifth fluid line 192 at both the supplemented pressure and the supplemented temperature, while delivered to the reservoir 122 at a substantially lower pressure and substantially lower temperature. To this end, the fifth fluid line 192 includes a condenser 198 and the expansion valve 160.

The condenser 198 is fluidly coupled to the distillation unit 144 via a leading portion 200 of the fifth fluid line 192 and is configured to receive and lower a temperature of the fuel in the gaseous state (methane vapor) relative to the supplemented temperature. The condenser 198 is configured to allow a passage of the methane vapor therethrough, and while methane vapor progresses through the condenser 198, the condenser 198 is configured to condense any quantity of propane, entrained by the methane vapor (fuel in the gaseous state), sooner than condensing the methane vapor itself. A sixth fluid line 202 is connected between the condenser 198 and the absorption unit 140 so as to allow the condensed propane to be returned to the absorption unit 140 as a liquid, thus ensuring greater percentage of propane recovery. In general, the condenser 198 may be a cross-flow heat exchanger that may receive the fuel in the gaseous state (methane vapor) into the condenser's tubes in a manner as is conventionally known. The condenser 198 may have a blower (not shown) positioned laterally to a flow of methane to dissipate heat of the fuel in the gaseous state towards a heat sink, such as a surrounding atmosphere 204. A cooling capacity of the condenser 198 may be varied by altering the blower's speed, for example. In general, a structure and configuration of the condenser 198 remains similar to several of the existing condenser units, and thus further description pertaining to the condenser 198 is not included.

In an exemplary embodiment, the condenser 198 is configured to reduce a temperature of the fuel in the gaseous state to 180 Kelvin from the supplemented temperature. However, a pressure of the fuel in the gaseous state may remain same as the supplemented pressure of 60 bar.

The expansion valve 160 is positioned downstream to the condenser 198 and fluidly coupled to the condenser 198 by an intermediate line portion 206 of the fifth fluid line 192. The expansion valve 160 is configured to receive and lower a pressure of the fuel in the gaseous state from the supplemented pressure, before permitting a liquefied fuel back into the reservoir 122. A reduction in pressure of the fuel in the gaseous state is also accompanied by a reduction in temperature of the fuel in the gaseous state, thereby cooling and condensing the fuel in the gaseous state before delivery. As a result, a re-entry of the fuel into the reservoir 122 is also marked by a reduction in the vapor quality ( [symbol] ≦1) of the fuel, as compared to the first vapor quality (i.e. [symbol] =1). Effectively, a substantial percentage, if not all, of the fuel in the gaseous state turns into liquid form before re-entering the reservoir 122. Persisting vapor portions within the re-entered fuel may be recirculated in the fuel recovery circuit 136 until all or any desired quantity of vapor (fuel in the gaseous state) turns back to liquid. liquefied fuel attained though the expansion valve 160 flows into the reservoir 122 by a return line 208 of the fifth fluid line 192.

In an exemplary embodiment, the expansion valve 160 is configured to reduce a pressure of the fuel in the gaseous state to 8 bar from the exemplary supplemented pressure of 60 bar, discussed above. Alongside, a temperature of 180 Kelvin is also reduced to about less than/equal to 145 Kelvin. In effect, the fifth fluid line 192 (or the cooling circuit 146) is configured to re-liquefy the fuel in the gaseous state that was initially received from the reservoir 122 via the first fluid line 164 as boil-off gas 132, to a temperature of about 145 Kelvin, pressure of about 8 bar, and a vapor quality of less than or equal to 1.

The heat exchangers 150, 152 are categorized as a first heat exchanger 150 and a second heat exchanger 152. In general, the heat exchangers 150, 152 work on a similar principle as the condenser 198. However, said heat exchangers 150, 152 imbibe a counter flow heat exchanging pattern, as a principle mode of operation.

In further detail, the first heat exchanger 150 is positioned between the first fluid line 164 (downstream to the shutoff valve 154) and the intermediate line portion 206 of the fifth fluid line 192. The first heat exchanger 150 acts as a first preheating station for the boil-off gas 132 exiting the reservoir 122 from the first fluid line 164 into the absorption unit 140. More specifically, the intermediate line portion 206 transfers a quantity of heat from the fuel in the gaseous state travelling through the intermediate line portion 206 to the boil-off gas 132 travelling through the first fluid line 164. In that way, boil-off gas 132 exiting the reservoir 122 through the first fluid line 164 is preheated to generally minimum degree. Also, in co-relation, the first fluid line 164 provides refrigeration to the intermediate line portion 206 via the first heat exchanger 150.

The second heat exchanger 152 is arranged between the second fluid line 168 and the fourth fluid line 182. The second heat exchanger 152 is positioned upstream to the expansion valve 158 on the second fluid line 168, along a flow of propane from the chamber 194 to the absorption unit 140. The second heat exchanger 152 is configured to transfer heat from the second fluid line 168 (obtained via the heating of the chamber 194 by the heating element 196) to the fourth fluid line 182. The second heat exchanger 152 generally acts as a second preheating station for the liquid solution 170 (boil-off gas 132 mixed and absorbed within the refrigerant) traveling from the absorption unit 140 to the distillation unit 144 via the fourth fluid line 182. The heat imparted to the fourth fluid line 182 facilitates the distillation unit 144 to impart a generally lower heat through the heating element 196 to the pressurized liquid solution, thus saving energy. In co-relation, the second fluid line 168 provides refrigeration to the fourth fluid line 182 via the second heat exchanger 152.

### INDUSTRIAL APPLICABILITY

When operating the machine 100 under relatively high temperature conditions or for a prolonged period, there remains an increased chance for the fuel stored cryogenically within the reservoir 122 to turn into boil-off gas 132. To reduce a resulting pressure increase, the condensation system 126 is applied to process and condense the boil-off gas 132 and return the boil-off gas 132 in a liquefied form to the reservoir 122.

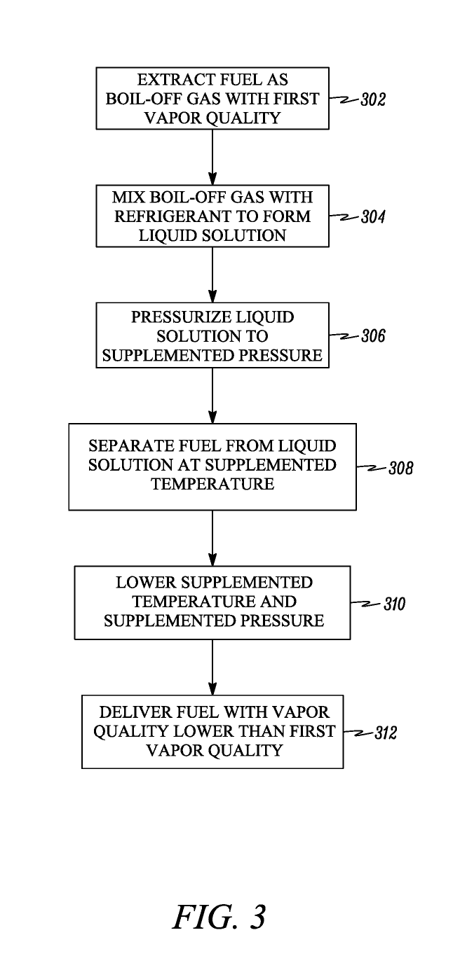

Referring to FIG. 3, an exemplary method of operation of the condensation system 126 is set out by way of a flowchart 300. The method is discussed in conjunction with FIGS. 1 and 2. The method initiates at stage 302.

At stage 302, as pressure rises within the reservoir 122, vapor is formed with a first vapor quality. As a result, the shutoff valve 154 opens owing to a resulting pressure differential existing across the first fluid line 164. For example, the pressure within the reservoir 122 may be around 6 to 8 bar, while a pressure within the absorption unit 140 may be around atmospheric pressure (approximately 1 bar). In an embodiment, the components of the condensation system 126 may be operably connected to a controller (not shown) that receives a pressure data from within the reservoir 122 on a periodic basis. As the pressure received breaches a predefined threshold, such as according to a pressure value stored within a memory of the controller, the controller may activate the shutoff valve 154 to the open state. Although the shutoff valve 154 may be automatically activated by the controller, an operator of the machine 100 may also manually switch the shutoff valve 154 to an open state, such as when an increased pressure condition within the reservoir 122 is observed. In an embodiment, an opening of the shutoff valve 154 may be based on a preset time pattern, as set by the controller or one of the machine's existing electronic control module (ECM). When manually controlling the shutoff valve 154, a pressure reading of the reservoir 122 may be read by the operator. An opening of the shutoff valve 154 facilitates an extraction of the boil-off gas 132 to the absorption unit 140 through the shutoff valve 154.

As the shutoff valve 154 opens, the boil-off gas 132 starts to be released through the expansion valve 156. As a result, boil-off gas 132 losses pressure and cools to a relatively low temperature, forming a low temperature stream downstream to the expansion valve 156. As the low temperature stream passes through the sequentially arranged heat exchanging section 178, a portion of boil-off gas 132 within the reservoir 122, surrounding the heat exchanging section 178, interacts with the low temperature stream, condenses, and falls into the reservoir 122 under gravity. Effectively, the heat exchanging section 178 forms a first part fuel re-liquefier, while the remaining part of the fuel recovery circuit 136 forms the second part fuel re-liquefier. As the boil-off gas 132 passes further through the first fluid line 164, the boil-off gas 132 receives heat from the first heat exchanger 150, as provided by the intermediate line portion 206 of the fifth fluid line 192. The first heat exchanger 150 acts a first preheating station for processing the boil-off gas 132. The first heat exchanger 150 imparts an initial measure of heat to the boil-off gas 132 passing therethrough (through the first fluid line 164). The method proceeds to stage 304.

At stage 304, the first fluid line 164 facilitates the boil-off gas 132 to be transferred to the absorption unit 140. Once the boil-off gas 132 is received into the absorption unit 140, the absorption unit 140 facilitates a mixing and absorption of the boil-off gas 132 with the refrigerant (propane) that is received into the absorption unit 140 though the second fluid line 168 (from the generator assembly 166). A mixture of the boil-off gas 132 and the refrigerant forms the liquid solution 170. The method proceeds to stage 306.

At stage 306, the pump 142 initiates operation and receives the liquid solution 170 via the third fluid line 180 by a pumping action. The pump 142 pressurizes the liquid solution 170 to a supplemented pressure, and delivers the liquid solution 170 into the fourth fluid line 182. In one example, the supplemented pressure is 60 bar. As the liquid solution 170 passes into the fourth fluid line 182, the heat exchanger 152, positioned downstream to the pump 142, receives the pressurized liquid solution 170. As a result, the liquid solution 170 gathers additional heat from the second fluid line 168 (this is because the second fluid line 168 facilitates transportation of propane heated by the heating element 196 positioned within the chamber 194). The heat exchanger 152 forms the second preheating station, as aforementioned. The method proceeds to stage 308.

At stage 308, the distillation unit 144 receives the pressurized liquid solution. As heat is applied by the heating element 196, the distillation unit 144 facilitates a separation of the liquid solution 170 into methane vapor (fuel in the gaseous state) and liquefied propane. While methane vapor escapes from the first end portion 186 of the fractional distillation column 184, at both a supplemented temperature and the supplemented pressure, liquefied propane flows down though the sinuous flow path defined by the packing trays 190, under the action of gravity, into the chamber 194 of the generator assembly 166. The liquefied propane is also maintained within the chamber 194 at the supplemented temperature and supplemented pressure. As there exists a pressure differential across the second fluid line 168 (because the pressure difference existing between the absorption unit 140 (at exemplary 2 bar) and the chamber 194 (at exemplary 60 bar)), liquefied propane is returned to the absorption unit 140 as part of a cyclical process of fuel regeneration, through the second fluid line 168. A return of the liquefied propane to the absorption unit 140 is marked by a reduction of temperature. This is because as the liquefied propane passes through the heat exchanger 152, liquefied propane dissipates heat towards the liquid solution 170 passing through the fourth fluid line 182. Additionally, liquefied propane sustains a drop in pressure (in relation to the supplemented pressure) as the liquefied propane passes through the expansion valve 158 positioned further downstream on the second fluid line 168. The method proceeds to stage 310.

At stage 310, the cooling circuit 146 receives the methane vapor (fuel in the gaseous state) from the first end portion 186 of the fractional distillation column 184. As the fuel in the gaseous state passes into the fifth fluid line 192 of the cooling circuit 146, the fuel in the gaseous state sustains heat transfer when passing through the condenser 198. More particularly, the condenser 198 facilitates a reduction of the supplemented temperature of the fuel in the gaseous state. As condensation proceeds, any indefinite amount of propane entrained by methane vapor may be returned to the absorption unit 140 as liquefied propane, as within an appropriate temperature range, propane may condense sooner than methane. In an embodiment, a temperature change imparted by the condenser 198 is always above a boiling point of methane. Thereafter, the fuel in the gaseous state flows into the first heat exchanger 150 via the intermediate line portion 206 of the fifth fluid line 192. The heat exchanger 150 (that acts as the first preheating station) facilitates attainment of further reduction in temperature of the fuel in the gaseous state. This is because heat from the intermediate line portion 206 is transferred to the boil-off gas 132 flowing through the first fluid line 164. Next, the fuel in the gaseous state passes into the expansion valve 160, which facilitates attainment of a temperature and pressure that is substantially lower than the supplemented temperature and supplemented pressure. In effect, the cooling circuit 146 facilitates condensation of the fuel in the gaseous state before being delivered into the reservoir 122. The method proceeds to stage 312.

At stage 312, the cooling circuit 146 delivers the liquefied fuel to the reservoir 122. A pressure of delivery of the liquefied fuel is relatively higher than the storage pressure of the reservoir 122. However, the delivery is at a pressure and a temperature respectively lower than the supplemented pressure and the supplemented temperature, as attained by the expansion valve 160. Moreover, the expansion valve 160 also helps attain a lower than/equal to (i.e. [symbol] ≦1) vapor quality of the delivered in relation to the first vapor quality (i.e. [symbol] =1). The method ends at stage 312.

The condensation system 126 requires power to run the pump 142 and the heating element 196. As it is easier to pressurize a liquid solution than gas, energy required to operate the pump 142 is significantly less. Moreover, as it is contemplated that the heating element 196 is configured to provide heat that is discarded from an existing system of the machine 100, energy is reused and thus saved. A commensurate impact of such an approach may be appreciated as a cost of running the condensation system 126 becomes significantly less when compared to systems that work on other refrigeration cycles, such as compression refrigeration cycles.

In an embodiment, the components of the condensation system 126 may be contemplated as a retrofit assembly. Such an assembly may be customized and applied to multiple cryogenic based storage assemblies. In an embodiment, the retrofit assembly may be instituted and distributed as a kit of parts, such as comprising the disclosed components of the condensation system 126 along with the multiple fluid lines, fluid hoses, fasteners, etc., and may be assembled to the reservoir 122 (or an associated machine) as an aftermarket fitment. The kit of parts may also be modified based on an operational requirement as demanded by an actual environmental condition. For example, certain components may be added or removed, such as expansion valves (such as expansion valves 156, 158, 160) may be added at various locations on the fuel recovery circuit 136. Moreover, sizes and configurations of the component of the condensation system 126 may also change because of a reservoir capacity and spacing constraints of the associated machine.

Although the condensation system 126 is discussed in relation to a locomotive system (machine 100), concepts of the present disclosure may be suitably incorporated to different applications, applied in various other environments, such as those involving a storage of cryogenic fuels (for example liquefied natural gas (LNG)). Aspects of the present disclosure may also be applied to stationary machines and/or stationary reservoirs that are configured to hold a volume of cryogenic fuel. Therefore, the condensation system 126 need not be viewed as being limited to the disclosed embodiments alone. Further, values of temperature, pressure, vapor quality, etc., as disclosed above, have been merely included for illustrating one preferred mode of operating the condensation system 126, such as under certain specific environmental conditions. Also, these values enhance an understanding of an operational flow of the condensation system 126. However, such values may change depending upon varying environmental conditions and other operational parameters and requirements. These values need not be seen as limiting the aspects of the present disclosure in any way. Further, the condensation system 126 may work in the absence of one or more components described herein, as may be envisioned and applied by someone skilled in the art.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A condensation system for a reservoir configured to store a fuel cryogenically, a portion of the fuel existing as a boil-off gas in the reservoir with a first vapor quality, the condensation system comprising:
an absorption unit fluidly coupled to the reservoir, the absorption unit configured to receive a refrigerant and the boil-off gas and facilitate a mixing therebetween to form a liquid solution;
a distillation unit fluidly coupled to the absorption unit to receive the liquid solution at a supplemented pressure, and configured to separate the fuel to a gaseous state from the liquid solution; and
a cooling circuit fluidly coupled between the distillation unit and the reservoir, and configured to receive the fuel in the gaseous state from the distillation unit at the supplemented pressure and a supplemented temperature, and deliver the fuel to the reservoir at a pressure and a temperature respectively lower than the supplemented pressure and the supplemented temperature, and with a vapor quality lower than the first vapor quality.

2. The condensation system of claim 1, wherein the cooling circuit includes:
a condenser fluidly coupled to the distillation unit and configured to receive the fuel and attain the temperature; and
an expansion valve fluidly coupled to the condenser and configured to receive the fuel and attain the pressure, before a delivery of the fuel into the reservoir.

3. The condensation system of claim 1 further comprising a pump fluidly connected between the absorption unit and the distillation unit to pressurize the liquid solution to the supplemented pressure.

4. The condensation system of claim 3, wherein the pump is adapted to selectively pump and deliver the fuel to an engine.

5. The condensation system of claim 1 further including a supplementary expansion valve to receive the boil-off gas from the reservoir, at a pressure prevalent within the reservoir, and deliver the fuel in the gaseous state at a reduced pressure to the absorption unit.

6. The condensation system of claim 5, wherein the supplementary expansion valve is positioned within the reservoir.

7. The condensation system of claim 5 further including a heat exchanging section arranged downstream to the supplementary expansion valve, along a flow direction of the boil-off gas to the absorption unit, the heat exchanging section being positioned within the reservoir.

8. The condensation system of claim 1, wherein the fuel is Liquefied Natural Gas (LNG).

9. The condensation system of claim 1, wherein the refrigerant is Propane.

10. A storage system for a fuel, the system comprising:
a reservoir to store the fuel cryogenically, wherein a portion of the fuel exists as a boil-off gas in the reservoir with a first vapor quality;
an absorption unit fluidly coupled to the reservoir, the absorption unit configured to receive a refrigerant and the boil-off gas and facilitate a mixing therebetween to form a liquid solution;
a distillation unit fluidly coupled to the absorption unit to receive the liquid solution at a supplemented pressure, and configured to separate the fuel to a gaseous state from the liquid solution; and
a cooling circuit fluidly coupled between the distillation unit and the reservoir, and configured to receive the fuel in the gaseous state from the distillation unit at the supplemented pressure and a supplemented temperature, and deliver the fuel to the reservoir at a pressure and a temperature respectively lower than the supplemented pressure and the supplemented temperature, and with a vapor quality lower than the first vapor quality.

11. The storage system of claim 10, wherein the cooling circuit includes:
a condenser fluidly coupled to the distillation unit and configured to receive the fuel and attain the temperature; and
an expansion valve fluidly coupled to the condenser and configured to receive the fuel and attain the pressure, before a delivery of the fuel into the reservoir.

12. The storage system of claim 10 further comprising a pump fluidly connected between the absorption unit and the distillation unit to pressurize the liquid solution to the supplemented pressure.

13. The storage system of claim 12, wherein the pump is adapted to selectively pump and deliver the fuel to an engine.

14. The storage system of claim 10 further including a supplementary expansion valve to receive the boil-off gas from the reservoir, at a pressure prevalent within the reservoir, and deliver the boil-off gas at a reduced pressure to the absorption unit.

15. The storage system of claim 14, wherein the supplementary expansion valve is positioned within the reservoir.

16. The storage system of claim 14 further including a heat exchanging section arranged downstream to the supplementary expansion valve, along a flow direction of the boil-off gas to the absorption unit, the heat exchanging section being positioned within the reservoir.

17. The storage system of claim 10, wherein the fuel is Liquefied Natural Gas (LNG) and the refrigerant is Propane.

18. A method for condensing a fuel, cryogenically stored in a reservoir, the method comprising:
upon a presence of a portion of the fuel as a boil-off gas with a first vapor quality in the reservoir,
extracting the boil-off gas to an absorption unit;
mixing the boil-off gas with a refrigerant in the absorption unit to form a liquid solution;
pressurizing the liquid solution to a supplemented pressure by a pump;
separating the fuel into a gaseous state from the liquid solution, at a supplemented temperature, in a distillation unit;
lowering the supplemented temperature and the supplemented pressure of the fuel in the gaseous state by a cooling circuit; and
delivering the fuel to the reservoir at a pressure and a temperature respectively lower than the supplemented pressure and the supplemented temperature, and with a vapor quality lower than the first vapor quality.

19. The method of claim 18 further comprising, during extracting, reducing a pressure and temperature of the boil-off gas by passing the boil-off gas through an expansion valve, thereby forming a low temperature stream.

20. The method of claim 19 further comprising condensing at least a portion of the fuel in the gaseous state in the cooling circuit by receiving refrigeration from the low temperature stream.
